(19) United States
(12) Patent Application Publication
(10) Pub. No.: US 2004/0172336 A1
(43) Pub. Date: Sep. 2, 2004

(54) Method and apparatus for advertising objects

(76) Inventors: Peter Forsell, Zug (CH); Sten Persson, Stockholm (SE); Kurt Flodin, San Mateo, CA (US)

Correspondence Address: NIXON & VANDERHYE, PC, 1100 N GLEBE ROAD, 8TH FLOOR, ARLINGTON, VA, 22201-4714, US

(21) Appl. No.: 10/373,865

(22) Filed: Feb. 27, 2003

(51) Int. Cl. G06F 17/60

(52) U.S. Cl. 705/26

(57) ABSTRACT

A method and apparatus for advertising objects offered in advertisements by a central server (104), which are accessible therefrom over the Internet to user terminals capable of web browsing or network browsing. A file request is received from a file requesting user terminal (102A) for a file indicated in an advertisement accessed from the central server. At least one file storing user terminal (102B) is then determined, for transferring the requested file directly from the file storing user terminal to the file requesting user terminal, or to another user terminal by remote control. File transfers to a specific registered user terminal over the Internet can be controlled by a customer from any user terminal, and regardless of whether the file is used for presenting advertised objects or otherwise.

### TECHNICAL FIELD

The present invention relates generally to a method and apparatus for advertising objects in advertisements accessible for customers from a central server. In particular, the invention is concerned with controlling and facilitating the process of providing electronic files, used for describing and/or presenting such objects, to user terminals.

### BACKGROUND OF THE INVENTION AND PRIOR ART

In recent years, electronic trading systems have emerged allowing customers to purchase objects and services “over-the-web”. Basically, this is done by first accessing a web-based trading site or the like from a user terminal, such as a PC (Personal Computer) or a mobile phone, over the Internet. By accessing and browsing one or more suitable home pages of the trading site, information can be obtained on objects offered for sale or exchange or otherwise. The trading site is typically implemented as a central server in which such information on offered objects is stored and can be accessed by means of a user terminal equipped with Internet browsing functionality.

For example, if a customer decides to buy a certain item, a purchase order is typically issued to the central server from a user terminal operated by the customer. Certain messages are then exchanged in order to provide for charging, typically including a bank account number, various confirmations and possibly a prize negotiation. Normally, some security routine is also required before the purchase order is accepted and registered with the trading site or central server, for future delivery of the ordered item to the customer.

In order to provide information on offered objects, advertisements comprising such object information are created in the central server, which can be searched and retrieved by customers interested in the offered objects.

In the following description, the term “object” will be used to broadly represent any physical or non-physical object, such as an article, product, service, or piece of software. An object may be offered for sale or exchange or hire/rent or giveaway or just publication. Further, an “object” may also be a person, e.g., seeking contact or offering services. Objects may also be advertised as “wanted” objects. The term “client” will represent a person or a company or an institution, advertising and offering one or more objects, and the term “customer” will represent anyone accessing advertisements over the Internet in search for interesting objects.

Advertising clients are often interested in presenting their objects in a professional and informative manner. For this purpose, the advertisements may comprise attached electronic files for enhancing the presentation of objects. For example, a video animation or an audio presentation may be desirable to illustrate the performance and/or appearance of an object, in addition to the advertisement itself.

However, a central server serving many advertising clients has a limited storing capacity such that each advertisement can only be allocated a limited storing space in the central server for information display, including any files attached to the advertisements. Therefore, clients are restrained from using very sophisticated presentations on their objects, but are limited to use files, if any, of considerably reduced size compared to what may be desirable.

It is thus a problem in current solutions that clients have limited means for presenting advertised objects in advertisements accessible from a central server over the Internet. It is also a problem in current solutions that customers are restricted to retrieve only substantially limited amounts of information and presentations on advertised objects from a central server.

It is a further problem in current solutions that a customer may be prevented or restrained from retrieving certain information and presentations on advertised objects to a user terminal, due to restrictions imposed on that user terminal. Such restrictions may be firewalls, a limited storing capacity of that user terminal, or limited transmission capabilities, either in the terminal itself or in the communication path used for the terminal, such as a slow modem.

It is also a problem in current solutions that a customer may be prevented or restrained from generally retrieving any kind of electronic files over the Internet to a user terminal, e.g. due to restrictions, as exemplified above, imposed on that user terminal.

### SUMMARY OF THE INVENTION

An object of the present invention is to reduce or eliminate the problems outlined above. In particular, it is an object to enable clients to advertise objects in advertisements accessible from a central server over the Internet, and to use fairly large amounts of information for presenting objects, regardless of any storing limitations in the central server.

It is another object of the present invention to enable customers to retrieve fairly large amounts of information and presentations on advertised objects offered in advertisements accessible from a central server.

It is another object of the present invention to enable customers to retrieve information and presentations on advertised objects, regardless of restrictions imposed on a currently used user terminal, such as firewalls, limited transmission capacity, or limited storing capacity.

It is another object of the present invention to enable clients to provide electronic files to customers for their advertised objects, without the clients themselves necessarily being connected to the central server or to the Internet.

It is another object of the present invention to enable customers to generally retrieve any kind of electronic files over the Internet in a flexible manner, regardless of restrictions imposed on a currently used user terminal.

These objects and others are obtained by a method and a central server according to the appended claims.

According to one aspect of the invention, a method and a central server for advertising objects are provided, wherein objects are offered in advertisements stored in the central server, which are accessible over the Internet to user terminals capable of web browsing or network browsing. A request is received in a receiving unit from a first user terminal for at least one electronic file used for describing and/or displaying one or more objects. The at least one requested file is indicated in an advertisement accessed from the central server by the first user terminal. The at least one file is further distinct from the one or more objects offered in the advertisement. Hence, the file is only used for describing and/or presenting the advertised object, and is not the actual object.

At least one second user terminal is then determined by a logic unit, which terminal is registered with the central server as having the at least one requested file availably stored therein, in response to the received file request, and based on file information stored in a server database. A communication connection between the first and second user terminals is initiated by a transmitting unit if the first user terminal requests a file transfer to the first user terminal. The at least one requested file can then be transferred directly from the second user terminal to the first user terminal, in a so-called peer-to-peer transfer. The file is transferred by means of file transfer enabling computer programs installed in the first and second user terminals, respectively, without requiring any further action from the central server. The transmitting unit initiates the communication connection between the first and second user terminals by sending a file transfer command to the first user terminal to activate the file transfer enabling computer program in the first user terminal for pulling the at least one requested file from the second user terminal.

According to other aspects of the present invention, a method and a central server for advertising objects are provided, wherein a communication connection is initiated between the determined second user terminal and a third user terminal being registered with the central server, if the first user terminal requests a file transfer to the third user terminal. The at least one requested file is then transferred directly from the second user terminal to the third user terminal instead of to the first user terminal, wherein said first user terminal acts as a remote control user terminal from which the file request is received.

A file transfer enabling computer program has previously been installed in the third user terminal, enabling the third user terminal to receive the at least one requested file from the second user terminal. Further, a customer controlling the first and third user terminals has been assigned a login ID/password combination by the central server, which is valid for at least the third user terminal. A remote file request can then be sent by the customer from any terminal, provided that the correct login ID/password combination is entered.

According to different aspects of the present invention, this remote control function may be used for transferring files when advertising objects offered in advertisements stored in the central server, said advertisements being accessible from the central server over the Internet to user terminals capable of web browsing or network browsing. The remote control function may also be generally used for supplying electronic files to user terminals capable of web browsing or network browsing, the files being accessible by means of a central server over the Internet.

According to another aspect of the present invention, a method and a central server for advertising objects are provided, wherein a registration unit registers a client with the central server including defining client data. The registration unit creates an advertisement in the central server for the registered client based on the defined client data. The registration unit further indicates in the advertisement at least one file being stored locally in at least one registered user terminal. The at least one indicated file is used for describing and/or displaying one or more objects offered in the advertisement. The at least one indicated file is further distinct from the one or more objects offered in the advertisement.

Information on the at least one indicated file and the at least one file storing user terminal is stored in a server database of the central server. When a receiving unit in the central server receives a file request for the at least one indicated file from a user terminal accessing said advertisement from the central server, a logic unit determines at least one file storing user terminal in response to the received file request. A transmitting unit in the central server then initiates a communication connection for transferring the at least one indicated file from the determined file storing user terminal to the file requesting user terminal accessing the advertisement from the central server and requesting that file.

The file requesting user terminal is also registered with the central server as having said at least one requested file availably stored therein after being transferred, wherein a file transfer enabling computer program installed in the file requesting user terminal enables the file requesting user terminal to send the at least one requested file to any other user terminal also requesting that file.

According to further embodiments, at least one client profile is created and stored in the central server for the registered client, wherein the client profile is defined by profile data and is associated with a set of advertisements. A login ID/password combination is assigned to the client profile, authorizing the registered client to modify the profile and to add or remove advertisements associated with the profile, if the correct login ID/password combination is entered. The assigned login ID/password combination can also preferably be used for controlling file transfers to user terminals.

According to another aspect of the present invention, a method is provided for supplying electronic files to user terminals capable of web browsing or network browsing, said electronic files being accessible by means of a central server over the Internet. A request is received in said central server from a first user terminal for at least one electronic file indicated by the central server when accessed by the first user terminal. At least one second user terminal being registered with the central server is determined as having the at least one requested file availably stored, in response to the received file request. A communication connection is then initiated between the second user terminal and a third user terminal being registered with the central server, such that the at least one requested file can be transferred directly from the second user terminal to the third user terminal.

The file may be transferred from the second user terminal to the third user terminal by means of file transfer enabling computer programs installed in the second and third user terminals, respectively, without requiring any further action from the central server.

A file transfer enabling computer program may have previously been installed in the third user terminal, enabling the third user terminal to receive the at least one requested file from the second user terminal.

Initiating the communication connection may include the central server sending a file transfer command to the third user terminal to activate said file transfer enabling computer program in the third user terminal for pulling the at least one requested file from the second user terminal. The file transfer command may include a network address of the second user terminal and the storing location of the requested file in the second user terminal.

Initiating the communication connection may alternatively include the central server sending a file transfer command to the second user terminal to activate said file transfer enabling computer program in the second user terminal for pushing the at least one requested file to the third user terminal. The file transfer command may include a network address of the third user terminal and the storing location of the requested file in the second user terminal.

Preferably, a customer controlling the first and third user terminals has been assigned by the central server a login ID/password combination which is valid for at least the third user terminal, such that a remote file request can be sent from any terminal, provided that the correct login ID/password combination is entered.

The third user terminal may be registered with the central server as having said at least one requested file availably stored therein after being transferred, wherein a file transfer enabling computer program installed in the third user terminal enables the third user terminal to send the at least one requested file to any other user terminal also requesting that file.

According to another aspect of the present invention, a central server is provided for supplying electronic files to user terminals capable of web browsing or network browsing, said electronic files being accessible by means of the central server over the Internet. The central server is adapted to perform the above-described method, and comprises a receiving unit adapted to receive a request from a first user terminal for at least one electronic file indicated by the central server when accessed by the first user terminal. The central server further comprises a server database for storing file information on a plurality of files and their associated user terminals in which those files are locally stored. The central server further comprises a logic unit adapted to determine at least one second user terminal being registered with the central server as having the at least one requested file availably stored, in response to the received file request. The central server further comprises a transmitting unit adapted to initiate a communication connection between the second user terminal and a third user terminal being registered with the central server, such that the at least one requested file can be transferred directly from the second user terminal to the third user terminal.

The central server may be adapted to send file transfer enabling computer programs to the second and third user terminals, enabling the file to be transferred from the second user terminal to the third user terminal, without requiring any further action from the central server.

The central server may further be adapted to send a file transfer enabling computer program to the third user terminal, enabling the third user terminal to receive the at least one requested file from the second user terminal.

The present invention can be used to overcome any storing limitations in the central server for presenting advertised objects offered in advertisements, since object files indicated in advertisements are stored locally in user terminals available for file transfer or downloading to customers. Customers will thus also be able to select from practically unlimited amounts of information and presentations on advertised objects, offered in advertisements accessible from a central server, by retrieving or downloading files from any local terminal computer. Moreover, clients are enabled to provide electronic files for their advertised objects to customers, without the client's user terminal-necessarily being connected to the central server or to the Internet, since a file can be available from one or more other user terminals having earlier received that file.

Since object files can be retrieved by remote control, customers are further enabled to retrieve information and presentations on advertised objects, regardless of which user terminal is currently used and the current location, and regardless of any restrictions imposed on the used user terminal by means of firewalls, limited transmission capacity, limited displaying capacity, or limited storing capacity. For example, a web-browsing mobile telephone with low transmission and storing capacity can be used at any location to control a file transfer to a more powerful PC located at home. Moreover, customers are enabled to retrieve over the Internet any electronic files made accessible by the central server, regardless of restrictions imposed on a currently used user terminal. Files transfers to a specific registered terminal can then be controlled from any user terminal in a flexible manner.

The inventive feature of supplying electronic files by remote control, i.e. by one terminal requesting a file transfer to another terminal, provides considerably increased freedom to users. This is particularly important since computers in office environments, at work etc, are getting more and more restricted or “locked in”, e.g. by means of sophisticated firewalls, limiting the freedom for users. Moreover, small portable terminals, such as the upcoming powerful mobile telephones having sophisticated functionality, will be very efficient and easy to use together with this feature. Controlling peer-to-peer file transfers remotely is a new and unique feature which is suitable for any electronic files, regardless of whether the file is used for presenting advertised objects or otherwise.

### BRIEF DESCRIPTION OF THE DRAWINGS

The present invention will now be described in more detail and with reference to the accompanying drawings, in which:

FIG. 1 is a schematic view of a simplified communication scenario in which the present invention can be used.

FIG. 2 is a schematic block diagram of a central server communicating with user terminals.

FIG. 2a is an exemplary server database register for advertisement files.

FIG. 3 is a flow chart illustrating the steps executed in an exemplary procedure for providing information and/or presentations on objects to user terminals.

FIG. 4 is a schematic view of a communication scenario for remotely requesting a file to a user terminal.

FIG. 5 is a flow chart illustrating the steps executed in an exemplary procedure for providing information and/or presentations on objects by registering a user terminal with the central server and creating an advertisement.

### DESCRIPTION OF PREFERRED EMBODIMENTS

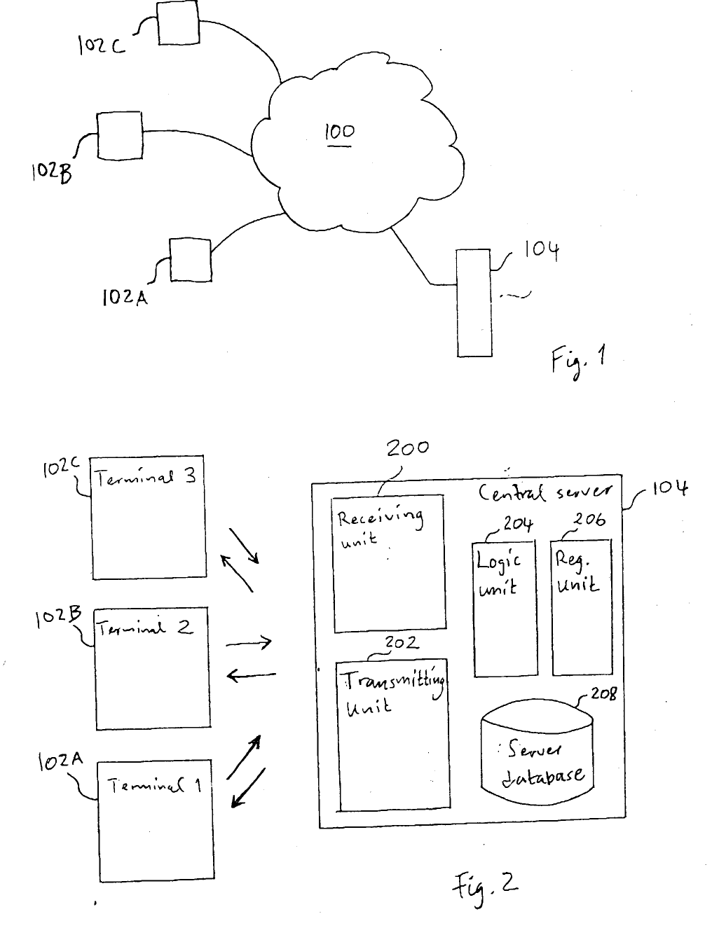

In FIG. 1, an exemplary schematic communication scenario is illustrated in which the present invention can be used. 100 generally denotes a multitude of communication networks, today collectively known as the Internet. A multitude of user terminals are connected to the Internet 100, and in this example, only three user terminals 102A-C are shown. The present invention can generally be applied for any type of user terminals or devices capable of communication over the Internet, such as PCs, work stations, TV sets, game stations and mobile stations. Thus, it is assumed that the user terminals 102A-C are capable of Internet browsing, sometimes referred to as web browsing or network browsing.

The user terminals 102A-C are connected to the Internet 100 by means of any suitable access networks, such as a PSTN (Public Service Telephony Network) or a mobile network, not specifically shown. The user terminals 102A-C can thereby communicate with Internet servers, and also mutually with each other. Any suitable known methods and systems for such communication may be used for the present invention, and will therefore not be described here further.

Furthermore, also connected to the Internet 100 is a central server 104 which is used for electronically displaying advertisements for objects. Alternatively, the central server 104 may be used for generally offering electronic files over the Internet. In practice, the central server 104 may be implemented as a single central unit, or as a plurality of distributed sub-units, e.g. at different locations. Moreover, one or more user terminals may act as a central server, within the scope of the present invention. For example, it may be preferable to use an arrangement with alternating local computers acting as the central server.

Advertisements are thus created for clients who want to offer objects to customers. The central server 104 may for example act as a trading site for objects offered for sale to customers. However, the present invention is not limited to specific objects but can be used for any kind of objects offered by clients for sale or exchange or hire/rent or giveaway or just publication. Thus, the term “offered object” should be understood in the broadest sense, as described in the background section. According to certain aspects of the present invention, it is applicable for generally supplying any kind of electronic files over the Internet.

Advertisements are displayed electronically in one or more suitable “home pages” or the like by the central server 104, which can be accessed by any user terminal equipped with web browsing or network browsing functionality, such as the user terminals 102A-C. In practice, the central server 104 may comprise, among other things, a suitable customer interface for communication with user terminals accessing the advertisements, and a suitable client interface for communication with registered clients. Any suitable communication interfaces, not shown, may be used for the present invention, and will therefore not be described here further.

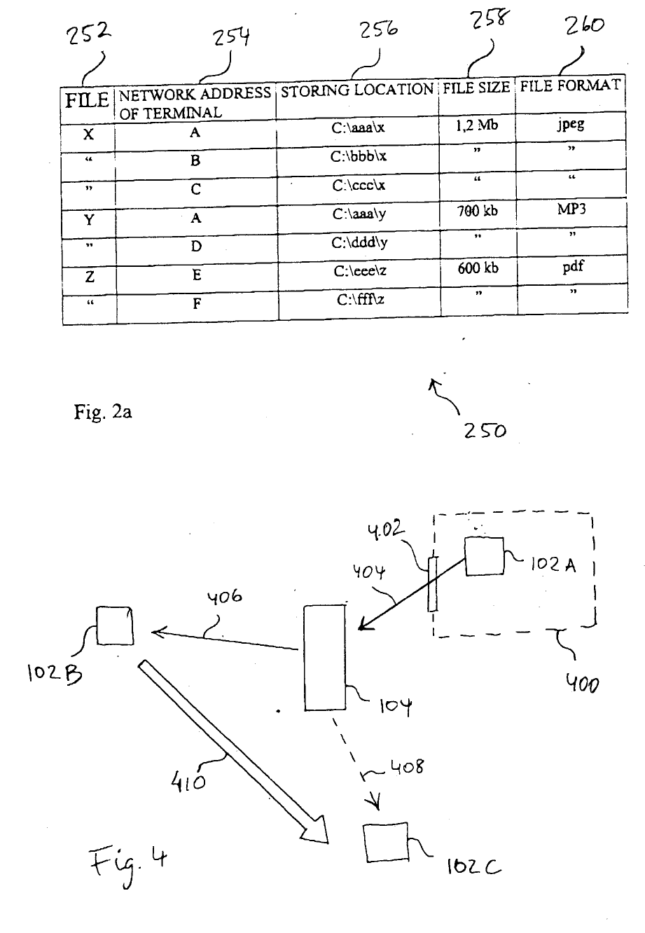

In FIG. 2, the central server 104 is logically illustrated in more detail, as well as the three user terminals 102A-C. The central server 104 comprises a receiving unit 200 for receiving messages such as file requests, a transmitting unit 202 for sending messages, e.g. to initiate communication connections between user terminals, and a logic unit 204 for processing data and messages and for making decisions. The central server 104 further comprises a registration unit 206 for registering clients and file storing user terminals and for creating advertisements for clients, and finally a server database 208 for storing information on clients, advertisements and files.

These different server components 200-208 should merely be considered as logical function units having characteristics described below, which in practice can be implemented by using any suitable combinations of hardware and software to provide the described functions. For example, the server database 208 may be physically located either in the central server 104 or remotely. In the following description, the server database 208 is logically considered to be a part of the central server 104, regardless of practical implementation. Further, it is assumed that the user terminals 102A-C are equipped with suitable memory and processor means, not shown, in order to be involved in the inventive methods described below.

In accordance with specific aspects of the present invention, electronic files can be used by clients for enhancing the presentation of their offered objects in the following manner: Such files can be indicated in the advertisements, while being availably stored locally at user terminals, and not necessarily stored in the central server 104. Thus, the central server 104 does not need to store these files, but will upon request initiate a file transfer connection between a file requesting user terminal and a file storing user terminal. However, this does not exclude that some files indicated in advertisements may be stored at the central server 104, being available for browsing customers in addition to files locally stored in user terminals. It may thus be desirable to have a limited number of files stored in the central server 104, available for quick and easy access.

A register for electronic files, e.g. used for advertisements, may in practice be maintained in the server database 208. FIG. 2a illustrates an exemplary database register 250, comprising a file identity column 252, a network address column 254, a storing location column 256, a file size column 258 and a file format column 260. A column for transmission rates of the file storing user terminals, not shown, may also be included in the database register 250.

In this example, the register 250 contains a file X in jpeg format of 1,2 Mb size, which is currently stored in three different user terminals, having the network addresses A, B and C, respectively, where the file X is located in C:\aaa\x of terminal A, in C:\bbb\x of terminal B and in C:\ccc\x of terminal C. Further, a file Y in MP3 format of 700 kb size, is stored in two terminals, having network addresses A and D, respectively. Finally, a file Z in pdf format of 600 kb size, is stored in two terminals, having network addresses E and F, respectively.

In the following, interaction between the different nodes and components shown in FIG. 1 will be described in the context of the present invention, and any further well-known functions needed to practically implement the invention are omitted for the sake of conciseness.

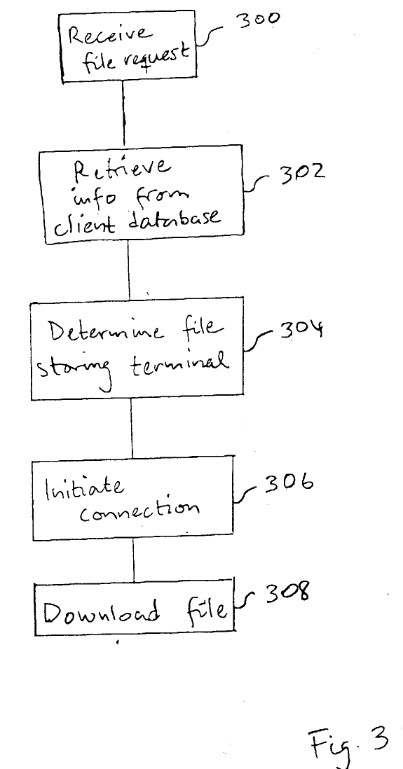

An exemplary procedure for providing information and/or presentations on objects to a customer controlling a first user terminal 102A will now be described with reference to the flow chart illustrated in FIG. 3, and with further reference to FIG. 2.

It is assumed in this example that a second user terminal 102B has previously been registered with the central server 104 as storing an electronic file indicated in a previously created advertisement. The user terminal 102B may be the original file storing terminal controlled by the client for which the advertisement was created, or may be a user terminal having previously requested and received the file, or a “copy” thereof, expressed differently. The file may also be available from further user terminals being registered as having the file stored, not shown. The indicated file is used by the client for presenting one or more objects offered in the advertisement, and may be of any type, such as: text, image, voice, audio and video, of any size and format. Further, a plurality of such files, in any combination, may be indicated in the same advertisement, or one specific file may be indicated in plural advertisements.

It is further assumed that information has been stored in the server database 208 regarding the file and the file storing user terminal 102B when the advertisement was created or when the file was transferred to the user terminal 102B. The stored information may include a file format, a file size, a network address of the file storing user terminal, and the storing location therein of the requested file. This information may be stored in a database register, such as illustrated in FIG. 2a. The stored information may further include a transmission rate that the file storing user terminal is capable of providing, which will be described in more detail below.

In a first step 300 of the flow chart in FIG. 3, a file request is received in the receiving unit 200 of the central server 104 from a first user terminal 102A controlled by a customer accessing the advertisement, and who is interested in the one or more objects offered therein. A file request may embrace at least one file indicated in the advertisement. In this example, only one file is requested. However, a plurality of files may well be included in the same request within the scope of the present invention. In practice, the file request may effectively be sent to the receiving unit 200 from the first user terminal 102A when the customer clicks or otherwise activates the file indication in the advertisement.

It is important to note that in this aspect of the present invention, the requested file is distinct from the one or more objects offered in the advertisement. Hence, the file is only used for describing and/or presenting the advertised object, and is not the actual object.

The received file request is forwarded to the logic unit 204 for further processing. In response to the received file request, the logic unit 204 retrieves information on the requested file from the server database 208, in a next step 302, such as from the register 250 in FIG. 2a. This file information includes information on one or more user terminals registered with the central server as storing that file. More specifically, the retrieved file information may include the file format, file size, network address of any user terminal storing the file, and storing location of the file therein, e.g. as being available from the register 250.

In a further step 304, the logic unit 204 determines the second user terminal 102B as having the requested file availably stored therein, by means of the retrieved file information. In this determination step, it is also checked if the second user terminal 102B is currently connected on-line, i.e. is logged on to the Internet, in order to receive a file transfer command from the central server 104 to send the requested file to the first user terminal 102A.

If more than one second user terminal are determined, each storing the requested file, any number of the determined file storing terminals may be selected for sending the file. Another situation may be that, for example, two user terminals are registered in the server database 208 as storing the requested file, but one of them is currently not connected on-line. Two or more user terminals may also be selected for sending different parts of the file simultaneously, such as the most rapidly transmitting user terminals, which will be described below.

Next, in a step 306, the transmitting unit 202 initiates a communication connection between the first and second user terminals 102A,B, if the first user terminal 102A has requested a file transfer to itself. According to one important embodiment of the invention, the first user terminal 102A can alternatively request a file transfer to another user terminal, such as terminal 102C, which will be described in more detail below.

Initiating the connection includes sending a file transfer command from the transmitting unit 202 to one of the terminals 102A and 102B. The file transfer command may be sent to the second user terminal 102B to send, or upload, or “push” the requested file to the first user terminal 102A. In that case, The file transfer command includes the network address of the first user terminal 102A, such as an IP address. Alternatively, The file transfer command may be sent to the first user terminal 102A to fetch, or download, or “pull” the file from the second user terminal 102B. In that case, The file transfer command includes the network address of the second user terminal 102B. The selection of terminal to which the file transfer command is to be sent, depends on whether any firewall regulations prevents the second user terminal 102B from sending the file when pulled by the first user terminal 102A. Normally, the first user terminal 102A can connect to the second user terminal 102B and receive the file. However, If the second user terminal 102B is behind a firewall, then the central server 104 will send a push request asking the second user terminal 102B to initiate a connection making it possible for the first user terminal 102A to receive the file.

If this is the first time the first user terminal 102A sends a request to the central server 104 for a file transfer, i.e., the first user terminal 102A has not been previously registered with the central server 104, the first user terminal 102A is first requested to fetch, or download, a file receive enabling computer program from the central server 104. The file receive enabling computer program is then fetched and installed in the first user terminal 102A, and the program is adapted to, among other things, enable file transfer connections and operations.

Alternatively, the first user terminal 102A may already have the file receive enabling computer program previously installed therein, which has been received during a previous initial registration procedure, e.g. in connection with a first file request and file transfer operation. In that case, the computer program has been started in the first user terminal 102A, either by means of an auto-start function or manually by the user, and is activated in response to the file transfer command. The file receive enabling computer program is further adapted to receive and store the requested file.

By executing the file receive enabling computer program in the receiving first user terminal 102A, a connection is thus established with the second user terminal 102B, and the requested file is also transferred therefrom. The sent file transfer command may further include the type, size and storing location of the requested file in the second user terminal 102B.

Generally, when a file is stored in a user terminal to be available for transfer, the file is preferably “tagged” by means of an identity code identifying the file, which is added to the file when stored. This identity code can then be used for retrieving the file from a file storing user terminal, instead of using the file name, which may be changed by a user, thereby making the file name not possible to use for retrieval. The identity code may be derived from the file as a check sum, or the like.

The file receive enabling computer program is thus stored in the first user terminal 102A. According to an inventive embodiment, the stored file receive enabling computer program can later be activated and controlled remotely from another user terminal. The file receive enabling computer program is then activated and controlled via the central server 104 over the Internet by sending a file transfer command from the central server.

In order to enable the file transfer from the file storing second user terminal 102B as well, a previously received file send enabling computer program has also been stored in the second user terminal 102B. The file send enabling computer program may thus have been sent to and stored in the second user terminal 102B during a registration procedure. Hence, the file transfer is executed by means of the file receive and send enabling computer programs now stored in the first and second user terminals 102A,B, respectively, without requiring any further action from the central server 104. In a preferred embodiment, the file receive and send enabling computer programs are integrated in a common file transfer enabling computer program, which is sent to a user terminal from the central server during a registration procedure for that user terminal, in connection with either a first file request and file transfer operation, or the creation of an advertisement having one or more files indicated.

Thus, in a final step 308 of the flow chart in FIG. 3, the requested file is transferred directly from the second user terminal 102B to the first user terminal 102A over the established connection by means of said file transfer enabling computer programs stored in the user terminals 102A and 102B, respectively.

After the file has been successfully transferred, the first user terminal 102A having received the file, or a copy thereof, is registered with the central server 104 as having the transferred file availably stored, by means of the registration unit 206. Registering storage of the file in the first user terminal 102A includes storing relevant information on the file and the user terminal in the server database 208, e.g. according to the database register 250 in FIG. 2a.

A separate file send enabling computer program may also be sent to and stored in the first user terminal 102A, if not already being integrated in a previously received common file transfer enabling computer program, as described above. Thereby, the file can later be transferred directly from the first user terminal 102A to any other user terminal also requesting that file, since the first user terminal can be determined as having the file availably stored, as in step 304, in response to a new file request. The file send enabling computer program may have been attached to or included in the above-mentioned file transfer command, which was sent in step 306. Alternatively, the first user terminal 102A may be prompted to fetch, or download, the file send enabling computer program from the central server 104, either before or after the file transfer to the first terminal has been executed.

In the inventive procedure described in FIG. 3, the central server 104 is involved in steps 300-306, but the final step 308 of transferring the file is performed by the first and second terminals 102A, 102B, without involving the central server 104. Such file transfers between user terminals is sometimes referred to as “peer-to-peer” file transferring. It is known today to utilize such peer-to-peer file transferring in the context of distributing music, films and various computer programs.

As mentioned above, the first user terminal 102A may, in step 300, alternatively request for a file transfer to another user terminal, such as the third user terminal 102C, according to a preferred embodiment of the invention. In some situations, it is not suitable, or even possible, to transfer a file to the user terminal requesting the file, due to restrictions imposed on that user terminal. Such restrictions may be firewalls, a limited storing and/or displaying capacity in the user terminal, or limited transmission capabilities of either the receiving terminal itself or in the communication path used for the terminal, such as a slow modem or a wireless connection with low bandwidth. In other cases, the user may simply not want to review the file on the currently used terminal, for whatever reason.

In this embodiment of the present invention, electronic files can be supplied by remote control, i.e. by one terminal requesting a file transfer to another terminal. Such file transfers by remote control may be used for generally supplying any electronic files, regardless of whether the file is used for presenting advertised objects or otherwise. With reference to the scenario illustrated in FIG'S. 1 and 2, a customer may use the first user terminal 102A as a remote control terminal to request a file transfer to the third user terminal 102C. With further reference to FIG. 4, the first user terminal 102A may be situated in a strictly controlled environment 400, such as an office having firewalls 402, and the third user terminal 102C, being controlled by the customer, may be located at home with no firewalls. In another example, the first user terminal 102A may be a mobile phone with limited storing and displaying capabilities, as well as limited transmission capabilities with respect to bandwidth, making file transfers unsuitable. In any case, the third user terminal 102C must of course be connected on-line to the Internet in order to receive a file, which may be checked by the central server 104 before initiating the connection.

Firstly, a file request 404, sent by the customer from the first user terminal 102A, is received in the central server 104. In this example, the customer has indicated, in a suitable manner, the third user terminal 102C as the destination for transferring the requested file or files. In general, a customer may be assigned a login ID/password combination during a registration procedure, which is valid for one or more registered user terminals. In this example, a customer controlling the first and third user terminals 102A,C has been assigned a login ID/password combination which is valid for at least the third user terminal 102C, according to his/her registration. It should be noted that the first user terminal 102A, used by the customer to send the file request, does not need to be registered with the central server. Hence, a remote file request can be sent from any terminal, provided that the correct login ID/password combination is entered.

Thus, when the customer sends a file request from the first user terminal 102A for a particular file transfer, he/she is prompted to enter the assigned login ID/password. After having successfully entered the correct login ID/password, he/she may be prompted to select a user terminal out of one or more user terminals being associated with the customer's login ID/password, according to his/her registration. The customer may then select the third user terminal 102C, e.g. a PC at home, to which the file is to be transferred. In this way, a customer can generally, by using any user terminal from anywhere, initiate a file transfer to a registered user terminal which is associated with the customer's assigned login ID/password combination.

Alternatively, the requested file may be transferred automatically to the third user terminal 102C, by means of defined customer data indicating the third user terminal 102C as a default destination for file transfers. Such customer data may have been defined and stored in the server database 208 during the above-mentioned registration procedure.

After determining the second user terminal 102B as having the requested file stored, a file transfer command 406 is sent to either the second user terminal 102B or the third user terminal 102C, for initiating a communication connection between the second and third user terminals 102B,C, in a similar manner as in step 306 described above for the first user terminal 102A. Thus, a file receive enabling computer program has already been previously fetched from the central server 104 by the third user terminal 102C, and is now stored therein. The file receive enabling computer program is adapted to enable reception of the requested file when executed. However, as mentioned above, the file receive and send enabling computer programs are preferably integrated in the same file transfer enabling computer program, which is generally sent to and stored in a user terminal during a registration procedure for that user terminal, before any file transfers take place.

Finally, the requested file can be transferred 410 directly from the second user terminal 102B to the third user terminal 102C, instead of to the first user terminal 102A. In this embodiment for remotely controlling file transfers, the requested file may be a file used for describing and/or presenting an advertised object, as described above, or any electronic file offered over the Internet, e.g. for distributing music, films, games, etc.

As mentioned above, more than one user terminal may be determined in step 304 as having the requested file stored, which means that the file can be transferred from any of the determined file storing user terminals, provided they are availably connected on-line. The logic unit 204 may select the most rapidly transmitting user terminals for file transfer, out of a plurality of determined user terminals.

The most rapidly transmitting user terminals may be selected dynamically as soon as the file transfer has been initiated from the determined user terminals having the file stored. The transmission rate is then checked for each sending terminal, and the most rapidly transmitting user terminals can be selected for transferring the remainder of the file, which is a well-known procedure in Peer-to-Peer transfers. Different portions of the requested file can be transferred more or less simultaneously from the selected user terminals to a file receiving user terminal, such as the first terminal 102A or third terminal 102C in the examples described above. Briefly described, the file is split into different parts where each part is collected, or transferred, from a separate terminal in parallel. If the transfer of one file part is finished ahead of other parts, another file part transfer may be started from that terminal, which is obviously a rapid one. Hence, the most rapidly transmitting user terminals can be utilized to collectively provide the complete file in the most rapid manner. The received complete file may be verified at the receiving terminal by calculating a checksum, or the like.

In this way, the file transfer process can be speeded up, and any slow connections of the selected file storing terminals can at least partly be overcome. Preferably, the file receiving terminal is enabled to receive such simultaneous file transfers by means of the above-mentioned file receive enabling computer program running in the receiving terminal.

The logic unit 204 may select the most rapidly transmitting user terminal based on transmission rates stored in the server database 208 for the determined file storing user terminals. The logic unit 204 may further update the stored transmission rates dynamically in the server database 208, based on executed file transfers from the respective user terminals. A transmission rate computer program previously installed in a user terminal may be adapted to measure the transmission rate for executed file transfers and report the measurement results to the central server 104 by sending a transmission rate report. According to different embodiments, each file transfer, or every n:th file transfer, may be measured and reported, or a predetermined number of file transfers may be measured and an average transmission rate may be calculated and reported to the central server 104. This procedure may be controlled by means of the transmission rate computer program in the user terminal, or by the central server.

According to another embodiment of the present invention, client profiles may be created and stored in the central server 104 for clients advertising objects. Each client profile is associated with a set of advertisements, and may be assigned a client login ID/password combination authorizing one or more clients to modify the profile and to add or remove advertisements associated with the profile, if the correct login ID/password combination is entered. Preferably, the same login ID/password combination is used for both the client profile and for the control of file transfers, e.g. as described above in connection with FIG. 4.

A created client profile is defined by profile data, which may include at least one of: contact information, geographical location, charging parameters, and one or more object categories. The created client profile can then be used for generally describing and/or presenting the client and his/her offered objects. The profile can also be used by customers for searching advertisements. For example, the central server 104 may provide a web-based search engine or the like, in which suitable profile data can be selected by customers to limit their searches for advertisements and objects. Each search by a customer can then be automatically adapted to the customer's preferences, as a so-called “auto-search”. For example, a specific geographic area and/or object category may be searched.

Contact information may include name, postal address, telephone numbers, e-mail, etc. Contact information may further include a created “profile file”, i.e. an electronic file used for presenting the client, such as a document, an image, and/or a video presentation. Geographical location may include, country, state and city. Charging parameters may include currency, billing details, etc. Object categories may include classification of objects offered in advertisements, which can be used by customers to search for specific types of objects.

Preferably, the object categories may be organized in a tree structure or the like, in order to facilitate searching by category. Below is an exemplary tree structure for advertised objects, where a suitable category code is indicated for each tree position or branch:

Motor vehicles (1,0,0)

Cars (2,1,0)

Brand a (3,2,0)

Brand b (4,2,1)

Brand c (5,2,2)

Trucks (6,1,1)

Brand d (7,6,0)

Brand e (8,6,1)

and so forth.

A created client profile may further include a plurality of client subprofiles, such that each client subprofile is valid for, or associated with, a predetermined set of advertisements created for a registered client. The subprofiles may be valid for different geographic areas, and/or different contact information. For example, a client subprofile may be created for each member of a family, or for different employees of a company. Moreover, each client profile or subprofile may be associated with specific object categories.

A client may thus create his/her own set of subprofiles, all connected to the same client account, for example. Moreover, an authorised client can administrate all his/her subprofiles by using a single login ID/password combination, e.g. for updating or modifying profile data. In this way, advertisements can be tied to specific client profiles or subprofiles.

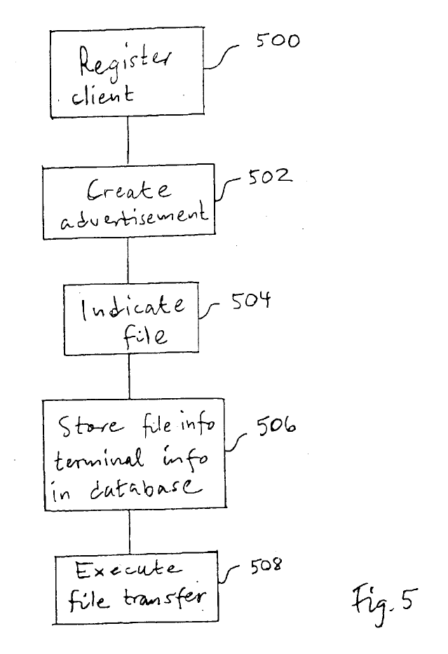

An exemplary procedure for advertising objects in a central server by registering a client with the central server 104 and creating an advertisement, will now be described with reference to the flow chart illustrated in FIG. 5.

In a first step 500, a client is registered with the central server, by means of the registration unit 206, by defining client data. Registering the client includes creating one or more client profile or subprofiles, as described above. The defined client data may thus include profile data for the client profile or subprofiles and a login ID/password combination. Further, the registration unit 206 creates an advertisement in the central server in a step 502 for the registered client, with respect to and based on the defined client data. Of course, more than one advertisement may be created in this step as well.

In a next step 504, the registration unit 206 indicates at least one electronic file in the created advertisement, the file being originally stored in at least one user terminal-controlled by the registered client. As in previously described examples, the indicated file is used for presenting, describing and/or displaying one or more objects offered in the created advertisement, or may be a profile file used for presenting the client. In this case, the file is distinct from the one or more objects offered in the advertisement.

Thereafter, in a step 506, information on the indicated file and the at least one file storing user terminal is stored in the server database 208, e.g. in a database register 250 as shown in FIG. 2a. The stored file information may include the file format, file size, network address of the at least one file storing user terminal, and storing location of the file therein, i.e. the kind of information retrieved in step 302 of the above-described procedure of FIG. 3. It is assumed that the at least one file storing user terminal also has the above-mentioned file send enabling computer program installed.

Finally, whenever a request is received for the indicated file, a file transfer may be executed from one or more file storing user terminals to any other user terminal for which a file request is made. Step 508 thus basically corresponds to steps 300-308 in the example of FIG. 3.

According to further embodiments, an advertisement may automatically be created by the central server 104 for one or more objects if a predefined condition is fulfilled, according to the defined client data. The predefined condition can be checked in different ways, within the scope of the invention. According to a preferred embodiment, an advertisement can be created automatically by means of an auto-client computer program, running in a processor or the like at the client, and being adapted to report the status of the object to the central server 104. The auto-client computer program is thus adapted to check whether said predefined condition is fulfilled, and if so, report this fact to the central server 104, which is then triggered to automatically create a predetermined advertisement for the object.

For example, if an object has previously been offered for sale by the client, otherwise than by advertising in the central server 104, e.g. in a shop, the predefined condition may be that, the object has remained unsold during a preset time period. The auto-client computer program thus detects the object being unsold when the preset time period has expired, and then triggers automatic creation of an advertisement in the central server 104.

A user terminal being registered as storing one or more files, may send a file availability report to the central server 104, comprising information on which files are available therein for transfer or downloading. The server database 208 in the central server is then updated according to the received file availability report. The file availability report may be received periodically, or each time the file availability in the registered user terminal is changed. Further, the file availability report may be sent together with the transmission rate report described above.

User messages, such as chat messages, may further be exchanged after a connection for file transfer has been established between two user terminals, independent of whether the file transfer is carried out or not. The exchanged user messages may comprise a negotiation for an advertised object, e.g. regarding the object's price or the like.

If a file transfer operation is interrupted before the complete file has been received from a file storing user terminal in a file receiving user terminal, the part of the file transferred so far may be stored in the receiving user terminal in a first file transfer attempt. Then, only the remainder of the partially stored file is transferred in a second attempt to the user terminal. This functionality may be implemented in the file transfer enabling computer programs running in the respective terminals, and is generally known per se for file transfers or downloadings, and will therefore not be described here further.

The present invention may be used when at least one of the involved user terminals, e.g. 102A-C, is a mobile phone. For example, a file request may be sent from a mobile phone, requesting a file transfer to a stationary PC by remote control, as described above, or requesting the file to be transferred to the mobile phone itself. Sophisticated and powerful mobile phones are currently emerging which are better equipped for receiving and presenting files.

In the following sections, messages used in an exemplary communication protocol are described, which can be used to implement the present invention in a central server.

Message Format

All messages send to/from servers and user terminals are in the format:

<length><type><data>

where <length> and <type> are 2 bytes each in big endian format (i.e. most significant byte first).

<length> specifies the number of bytes in the <data> portion of the message.

<type> specifies the type of message as describes below.

<data> contains all message parameters which are space separated. Strings are double quoted.

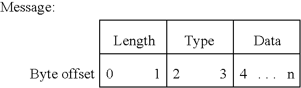

Fields

Below is a description of the parameters send or received in messages.

| Field | Description |
|---|---|
| <userid> | Unique user id used to determine |
| | identify the user. |
| <password> | The user password. In login message, |
| | before login user requests a random |
| | string and generate hash from |
| | password: |
| | “$1$” + ClientRandom + “$”+ |
| | MD5 (Password+ |
| | ServerRandom+ClientRandom) |
| | Where ClientRandom - Client side |
| | random generated string (a-zA-Z0-9) |
| | ServerRandom - Server side generated |
| | random string (a-zA-Z0-9) |
| | MD5 - standard MD5 hash function. |
| | If user requested for random string, |
| | he should use sent encrypted |
| | password. Of not requested, then he |
| | sent plain password. |
| | User should request server random |
| | string after each connection to |
| | server. |
| “<client- | The software version. |
| info>” | |
| <link> | Type of link of the user terminal. |
| | 0 - unknown |
| | 1 - 14.4 Modem |
| | 2 - 28.8 Modem |
| | 3 - 33.6 Modem |
| | 4 - 56.7 Modem |
| | 5 - 64K ISDN |
| | 6 - 128K ISDN |
| | 7 - Cable |
| | 8 - DSL |
| | 9 - T 1 |
| | 10 - T3 or greater |
| <ip> | Ip address as four bytes 0xC0, 0x41, |
| | 0x20, 0x06 would correspond to IP |
| | address 192.65.32.6 |
| <port> | The port the terminal is listening |
| | on for data transfer. 0 = behind a |
| | firewall and can only push files |
| | outward. |
| “<message>” | String containing a text message. |
| <response> | The string OK or FAIL. |
| <profile> | Profile identifier. |
| <infotype> | Info type identifier corresponding |
| | to a field in the database. |
| <anonymous> | A flag indicating that the client |
| | wants the profile to be anonymous. Y |
| | or N. |
| <info> | String containing information. The |
| | content depends on the type of |
| | information asked for. |
| <object> | Object identifier. |
| <category> | Category identifier. |
| <type> | Type of object. 0 = to sell, 1 = to |
| | buy, 2 = to exchange, 3 = to rent, 4 = to |
| | give away. Further types may be |
| | defined. |
| <number> | A number of fields to follow |
| <querytype> | Type of query. N = normal search, A = Agent |
| | search that will be stored |
| | in the server. |
| <hits> | Number of hits a search query |
| | returned. |
| <filename> | Complete filename including a path. |
| <fileindex> | File index created by owner of |
| | original file. This in combination |
| | with the <md5> is used to determine |
| | that the same file is located on |
| | several different terminals. |
| <md5> | MD5 hash |
| “Shared | Path to shared directories. It may |
| path” | be plain text or Base64 encoded, |
| | then added - at start of base 64. |
| “Downl path” | Path to shared directories. In the |
| | same format as Shared Path. |
| <ProtoVer> | Version of the protocol. |
| <RANDSTR> | Random generated string of |
| | alphabetic characters and digits. |
| [<pairs>] | This is a pair combination like |
| | CITY=STOCKHOLM or COUNTRY=SWEDEN. |
| | The left half of the pair contains a |
| | field name and the right half the |
| | field value. Strings are quoted like |
| | FIRSTNAME=“SVEN SVENSSON”. |

Messages

Below is a list of messages that can be send to/from user terminals and the server. The messages have been categorized. Each field is denoted with < > and separated by a single space character (ASCII 32). Strings containing the space character are passed using quotes, e.g. “this is a string containing the space character”. When the server responds to a request, the message type number is incremented by 1. In the FROM column, the term “CLIENT” represents any user terminal controlled by a client or a registered customer.

Login Messages

This section describes user login messages.

| Message | Description | Fields | From |
|---|---|---|---|
| 0x00 Error | Error message sent | “<message>” | CLIENT |
| | from server | | |
| 0x02 Login | User request to login | <nickname> | CLIENT |
| | | <password> | |
| | | <ip> | |
| | | <port> | |
| | | <link> | |
| | | <protover> | |
| | | “<client- | |
| | | info>” | |
| | | “Shared path” | |
| | | “Downl path” | |
| 0x03 Login | Server response to | <response> | SERVER |
| | 0x02 Login. The | [“<message>”] | |
| | <response> from the | | |
| | server will be OK or | | |
| | FAIL, and the | | |
| | optional <message> | | |
| | field a string with a | | |
| | message like “user | | |
| | not found”. | | |
| 0x04 ChgPass | User request to | <password> | CLIENT |
| | change his password | | |
| 0x05 ChgPass | Server response to | <response> | SERVER |
| | 0x04 Login. The | [“<message>”] | |
| | <response> from the | | |
| | server will be OK or | | |
| | FAIL and the optional | | |
| | <message> field a | | |
| | string with the | | |
| | message like “invalid | | |
| | password”. | | |
| 0x06 NewUser | User request to | <nickname> | CLIENT |
| | register itself as a | <password> | |
| | new user in the | <email> | |
| | server. | | |
| 0x07 NewUser | Server response to | <response> | SERVER |
| | new user. The | [“<message>”] | |
| | response is OK if the | | |
| | new user is accepted, | | |
| | otherwise FAIL and | | |
| | the user must try | | |
| | again. | | |
| 0x08 | Request for challenge | | CLIENT |
| GetRandom | from server | | |
| 0x09 | Server response with | <RANDSTR> | Server |
| SendRandom | random string | | |

Profile Messages

This section describes messages that can be used for updating client profile information on the server.

| Message | Description | Fields | From |
|---|---|---|---|
| 0x10 | Client request to | <profile> | CLIENT |
| UpdProfile | create new or update | <password> | |
| | an existing profile. | <postalcode> | |
| | The client sends all | <city> | |
| | profile information | <state> | |
| | and the server will | <country> | |
| | update accordingly. | <email> | |
| | If the profile | <www> | |
| | doesn't exist, a new | <type> | |
| | one will be created. | <dispemail> | |
| | Otherwise, the | <disptel> | |
| | existing one is | <dispmobil> | |
| | updated with the new | “<company>” | |
| | information. The | “<firstname>” | |
| | fields dispemail, | “<lastname>” | |
| | disptel and | “<street>” | |
| | dispmobile will tell | “<telephone>” | |
| | the server whether | “<mobile>” | |
| | to publish the | “<fax>” | |
| | email, telephone and | “<description>” | |
| | mobile information. | | |
| | If the profile type | | |
| | is business, then | | |
| | the company and | | |
| | address information | | |
| | will always be | | |
| | published. | | |
| 0x11 | Server response | <response> | SERVER |
| UpdProfile | | [“<message>”] | |
| 0x12 | Client request to | <profile> | CLIENT |
| DelProfile | delete a profile. | | |
| | This message is sent | | |
| | to the server every | | |
| | time a client | | |
| | removes a profile. | | |
| 0x13 | Server response | <response> | SERVER |
| DelProfile | | [“<message>”] | |
| 0x14 | A client can request | <nickname> | CLIENT |
| GetProfile | to get a specific | <profile> | |
| (N/A) | piece of information | [<infotype>, | |
| | about another | <infotype>, ..] | |
| | client's profile. | | |
| | *** define | | |
| | <infotype> | | |
| | email | | |
| | name | | |
| | www | | |
| 0x15 | Server response from | <nickname> | SERVER |
| GetProfile | the server will | <profile> | |
| (N/A) | return <info> in the | [<info>, ..., | |
| | same order as it was | <info>] | |
| | requested from the | | |
| | client. | | |
| 0x16 | This is a special | <number> | CLIENT |
| MyProfiles | function that the | [<profile1>] | |
| | client can use to | [<profile2>] | |
| | report all of his | ... [<profilen>] | |
| | profiles. The | | |
| | purpose of this | | |
| | function is to | | |
| | compare the profile | | |
| | stored on the server | | |
| | with the ones on the | | |
| | client. Only the | | |
| | profile identifiers | | |
| | are passed. Profiles | | |
| | found on server but | | |
| | not on client are | | |
| | removed from the | | |
| | server. Profiles on | | |
| | the client but not | | |
| | on the server are | | |
| | requested to be | | |
| | updated. | | |
| 0x17 | Server response to | <number> | SERVER |
| MyProfiles | MyProfiles message. | [<profilex>] | |
| | This message replies | ... [<profiley>] | |
| | with the number of | | |
| | profiles missing on | | |
| | the server and the | | |
| | profile identifier. | | |
| | The client should | | |
| | respond to missing | | |
| | profiles with an | | |
| | UpdProfile for each | | |
| | object that the | | |
| | server is missing. | | |

Object Messages

This section describes object related messages. These messages can be used to update information about objects in the network.

| Message | Description | Fields | From |
|---|---|---|---|
| 0x20 | Client request to | <object> | CLIENT |
| UpdObject | create a new or update | <profile> | |
| | an existing object. The | <category> | |
| | [<pairs>] fields are | <type> | |
| | category/type | [<pairs>] | |
| | dependant. | | |
| 0x21 | Server response | <response> | SERVER |
| UpdObject | | [“<message>”] | |
| 0x22 | Client request to | <object> | CLIENT |
| DelObject | delete an object | | |
| 0x23 | Server response | <response> | SERVER |
| DelObject | | [“<message>”] | |
| 0x24 | Get object information | <nickname> | CLIENT |
| GetObject | | <object> | |
| 0x25 | Server response to | <nickname> | SERVER |
| GetObject | GetObject. The | <object> | |
| | information returned | <category> | |
| | contains the complete | <type> | |
| | object data except for | [<pairs>] | |
| | the actual attachments. | | |
| | The [<pairs>] | | |
| | information is | | |
| | category/type | | |
| | dependant. The pairs | | |
| | that can always be | | |
| | returned from the | | |
| | profiles table are: | | |
| | Company, City, State, | | |
| | Country, Email, www, | | |
| | Mobile, Telephone and | | |
| | type. | | |
| | For business profiles | | |
| | the fields Street, | | |
| | PostalCode and the | | |
| | profile Description can | | |
| | be returned. | | |
| | Attachments are | | |
| | indicated by the pair: | | |
| | ATTACHMENT = | | |
| | “<filename>” | | |
| 0x26 | This is a special | <number> | CLIENT |
| MyObjects | function that the | [<object1>] | |
| | client can use to | [<object2>] | |
| | report all of his | ... [<objectn>] | |
| | objects. The purpose of | | |
| | this function is to | | |
| | compare the objects | | |
| | stored on the server | | |
| | with the ones on the | | |
| | client. Only the object | | |
| | identifiers are passed. | | |
| | Objects found on server | | |
| | but not on client are | | |
| | removed from the | | |
| | server. Objects on the | | |
| | client but not on the | | |
| | server are requested to | | |
| | be updated. | | |
| 0x27 | Server response to | <number> | SERVER |
| MyObjects | MyObject message. This | [<objectx>] | |
| | message replies with | ... [<objecty>] | |
| | the number of objects | | |
| | missing on the server | | |
| | and the object | | |
| | identifier. The client | | |
| | should respond to | | |
| | missing objects with an | | |
| | UpdObject for each | | |
| | object that the server | | |
| | is missing. | | |
| 0x28 | Notification of a | <object> | CLIENT |
| FileShared | shared file. <md5> is | <profile> | |
| | used in conjunction | <md5> | |
| | with the <size> and | <size> | |
| | <filename> to determine | “<filename>” | |
| | that other terminals | | |
| | may have the same file. | | |
| | If the object id is 0, | | |
| | then the file belongs | | |
| | to a the profile | | |
| | specified by <profile>. | | |
| | If the profile id is 0, | | |
| | then the file belongs | | |
| | to the object specified | | |
| | by <object>. | | |
| 0x29 | Server response | <respons> | SERVER |
| FileShared | | [“message”] | |
| 0x2A | Deletes one of the | <object> | CLIENT |
| DelFile | attached files. The | “<filename>” | |
| | filename is a relative | | |
| | path from a “shared | | |
| | folder”. | | |
| 0x2B | Server response | <respons> | SERVER |
| DelFile | | [“message”] | |
| 0x2C | The is used to delete | <number> | CLIENT |
| MyFiles | all of my shared files | | |
| | by passing the number 0. | | |
| 0x2D | The is the number of | <number> | SERVER |
| MyFiles | files that the server | | |
| | is sharing. | | |

Chat Messages

This section describes messages that can be used for communicating between users and checking whether users are reachable or not.

| Message | Description | Fields | From |
|---|---|---|---|
| 0x40 | User request to send | <nickname> | CLIENT |
| SendMess | message to other | <profile> | |
| | user(via server>. The | “<message>” | |
| | message will be | | |
| | forwarded to the | | |
| | “nickname” | | |
| 0x41 | Server message forward | <nickname> | SERVER |
| SendMess | to user. The user | <profile> | |
| | receiving this message | “<message>” | |
| | can use the <nickname> | | |
| | to find out who send | | |
| | the message. | | |
| 0x42 Ping | Ping. Can be sent both | <nickname> | CLI/SER |
| | from a user terminal | | |
| | or the server | | |
| 0x43 Pong | Pong. Can be sent both | <nickname> | CLI/SER |
| | from a user terminal | | |
| | or the server. | | |

Search Messages

This section describes messages used for searching.

| Message | Description | Fields | From |
|---|---|---|---|
| 0x50 Query | Send a search query to | <querytype> | CLIENT |
| | server. The querytype | <profileid> | |
| | determines whether this | <category> | |
| | is a regular query or | <type> | |
| | an agent query. The | [<pairs>] | |
| | [<pairs>] information | | |
| | is category/type | | |
| | dependant so the number | | |
| | and field types can | | |
| | vary. This information | | |
| | is a set of pairs like | | |
| | CITY = STOCKHOLM | | |
| | COUNTRY = SWEDEN etc.. | | |
| | <profileid> is used in | | |
| | ‘agent’ search for | | |
| | retrieving appropriate | | |
| | email address. | | |
| 0x51 | A query hit from the | <hits> | SERVER |
| QueryHit | server to user. The | <nickname> | |
| | results are sent as a | <object> | |
| | <nickname> <object> | [<nickname> | |
| | combination for each | <object>]... | |
| | hit. Using this set of | | |
| | hits the user can | | |
| | retrieve further | | |
| | details by applying the | | |
| | GetObject message. | | |

Download Messages

This section describes messages that can be used for downloading files.

| Message | Description | Fields | From |
|---|---|---|---|
| 0×60 | Request to download a | <nickname> | CLIENT |
| Download | file from another | <object> | |
| | terminal. | “<filename>” | |
| 0×61 | Server response to | <nickname> | SERVER |
| Download | download request. If | <ip> | |
| | 0, then the terminal | <port> | |
| | should try to use | <link> | |
| | PushReq message so | <object> | |
| | that the terminal | <md5> | |
| | having the file can | <size> | |
| | establish a connection | “<filename>” | |
| | to the requesting | | |
| | terminal. | | |
| 0×62 | Terminal request | <nickname> | CLIENT |
| PushReq | | <object> | |
| | | <fileindex> | |
| | | “<filename>” | |
| 0×63 | Server sends this | <nickname> | SERVER |
| PushReq | message to the | <ip> | |
| | uploading terminal | <port> | |
| | that logged in | <object> | |
| | indicating that he was | <fileindex> | |
| | behind a firewall. On | “<filename>” | |
| | receipt of this | | |
| | message, the uploading | | |
| | terminal should | | |
| | connect to the | | |
| | download terminal | | |
| | <nickname> <ip> | | |
| | <port>. | | |

Categories

This section describes messages related to categories in the system. There are structures describing how to show the categories in a tree view and the actual meta-data fields for each category. The client should always after a successful login retrieve an updated set of categories from the server.

| Message | Description | Fields | From |
|---|---|---|---|
| 0x70 | Request to download the | | CLIENT |
| CatStru | new set of categories | | |
| | and the structure. | | |
| 0x71 | Server response with | <numcat> | SERVER |
| CatStru | categories and the | [<catid> | |
| | category structure. The | “<catname>” | |
| | server will first return | <parentid> | |
| | the list of valid | <order> | |
| | categories and then | ]... | |
| | records from the | | |
| | catstruct table so that | | |
| | the client will receive | | |
| | the new category | | |
| | structure. | | |
| 0x72 | Request to download | | CLIENT |
| CatMeta | meta-data fields for | | |
| | each category | | |
| 0x73 | Server response with | | SERVER |
| CateMet | category meta-data | | |
| | fields | | |

File Downloads

The file download protocol may use HTTP. Normally, the downloading only requires the terminal to connect to the remote terminal and GET the file. If the remote terminal is behind a firewall, then the server will send a push request asking the remote terminal to initiate a connection making it possible for the downloading terminal to GET the file.

The terminal initiating the download sends a request string as shown below:

GET/get/<fileindex>/<filename>/HTTP/1.0\r\n

Connection: Keep-Alive\r\n

Range: bytes=0-\r\n

User-Agent: Servername\r\n

\r\n

The terminal receiving this request responds with the HTTP 1.0 compliant headers like this:

HTTP 200 OK\r\n

Server: Servername\r\n

Content-type: application/binary\r\n

Content-length: 123456789\r\n

\r\n

The file data then follows and the downloading terminal should read the number of bytes specified in the Content-length provided in the HTTP response.

In the next section, an exemplary database structure of the server database 208 will be described for a practical implementation of the present invention. The main tables in the database include information about users, clients, profiles, categories, objects and locally stored files.

Users

The table includes information about each registered user or client in the server. Every user may have one or more client profiles that can be used for various purposes. The user table contains generic client data. All objects “belong” to the various profiles, not the user. User logins are compared to this table before granted. only users with the status=0 will be accepted, provided that the nickname and password are correct. Banning a user will automatically ban all his profiles.

| Field | Type | Description |
|---|---|---|
| Userid | int 4 | This is a number internally used |
| | | for identifying the user. |
| Nickname | Varchar | Nickname. This name is unique in |
| | 80 | the server. When a client is |
| | | registered the very first time, |
| | | the user will be prompted to |
| | | supply a nickname and a password. |
| | | This nickname/password combination |
| | | will be used by the client |
| | | software every time it accesses |
| | | the network. |
| Password | Varchar 30 | This is the users password. Must |
| | | contain at least 6 characters. |
| Version | Varchar 255 | Client version used |
| Link | Tinyint 1 | Type of connection |
| Port | int 4 | Listen port. 0 = Behind a firewall |
| IP | Varchar 15 | IP address |
| Status | Tinyint 1 | The user status. 0 = Enabled, 1 = Banned. |
| Email | Varchar 80 | User's email address. This fields |
| | | is used when the user logs on the |
| | | first time and a default profile |
| | | is created. |

UserExt

This table contains extended client data such as billing address, real names, number of deals completed etc.

| Field | Type | Description |
|---|---|---|
| IntUserExtId | Int 4 | Primary key |
| Userid | Int 4 | User ID |
| Lastlogin | DateTime | The date and time the user |
| | | last logged on to the server. |
| Paidto | DateTime | The date the user login is |
| | | valid until. |
| LastMessage | DateTime | The date and time the last |
| | | message was received from the |
| | | client. The server can use |
| | | this to determine whether or |
| | | not the client connection has |
| | | timed-out. |

Profiles

This table keeps track of client profiles. Each profile may have it's own set of information.

| Field | Type | Description |
|---|---|---|
| IntProfileid | Int 4 | Primary key |
| ProfileID | Int 4 | Internal profile id needed to |
| | | create a unique key in the |
| | | table. |
| Userid | Int 4 | Userid |
| Password | Varchar 40 | Profile password on client |
| Company | Varchar 40 | Company name |
| Firstname | Varchar 40 | First name |
| Lastname | Varchar 40 | Last name |
| Street | Varchar 40 | Street |
| PostalCode | Varchar 10 | Postal code |
| City | Varchar 40 | City |
| State | Varchar 40 | State |
| Country | Varchar 40 | Country |
| Telephone | Varchar 30 | Telephone number |
| Mobile | Varchar 30 | Mobile telephone number |
| Fax | Varchar 30 | Fax number |
| Email | Varchar 80 | Email address |
| www | Varchar 80 | Web page |
| Description | Varchar 5000 | Personal description of |
| | | profile |
| Type | Bit | Type of profile. 0 - private, |
| | | 1 - business |
| Dispemail | Bit | Display Email address |
| Disptel | Bit | Display Telephone |
| Dispmobile | Bit | Display Mobile |

Category

This table contains a complete list of active categories and the structural relationships. An object may belong to any category. All categories may or may not contain sub categories.

| Field | Type | Description |
|---|---|---|
| Catid | Int 4 | Category ID. This is unique. |
| | | Always greater than 0. |
| Parentid | Int 4 | Parent ID. A parent ID of 0 |
| | | means that the category should |
| | | be present on the top level. |
| Sort | Int 4 | Order to be viewed in tree. The |
| | | category with the lowest Order |
| | | will be presented first. |
| Name | Varchar 80 | Name of the category |
| Enabled | Bit | Is this category used or not. |
| Created | DateTime | When the category was created |
| Updated | DateTime | When the category information |
| | | was updated |
| Icon | Varchar 128 | Path to icon to use for the |
| | | category |

A tree can be created using the catid, parentid and the order fields. The client should always download this information and the categories making sure that its is up to date. An exemplary category tree has been described above.

Objects

This table includes a basic structure that is common for all object types. Each object must belong to a client profile and a category. The Objectid and Userid create a unique object for the system. The fields in this table are used for all objects. The ObjFile table contains a reference to the actual table containing data for a specific object category.

| Field | Type | Description |
|---|---|---|
| IntObjectid | Int 4 | Internal object id used to |
| | | create a unique key in the |
| | | table. |
| Objectid | Int 4 | Object ID unique per client. |
| Userid | Int 4 | User ID owning the object. |
| Profileid | Int 4 | Profile ID owning the object. |
| Catid | Smallint 2 | Category ID |
| Type | Tinyint 1 | Type of object. 0 = Sell, 1=Buy, |
| | | 2= Exchange, 3 = For Rent, 4=To |
| | | rent, 5 = Give away. |
| Title | Varchar 64 | Title of object. |
| Description | Varchar 8000 | Object description in detail. |
| Price | Num | Object price. |
| | 9 (19,4) | |
| Currency | Varchar 3 | Currency of the price. |
| Inserted | DateTime | Date and time the object was |
| | | inserted. |
| Updated | DateTime | Date and time the object was |
| | | updated. |
| Active | Bit | Is the object active or not. |

ObjFile

This table includes a reference to the table that contains object data for each category.

| Field | Type | Description |
|---|---|---|
| Catid | Num 4 | Category ID |
| Objtable | Char 64 | Table used for holding object |
| | | data for the category. |

Files

This table together with FilesAux keeps a list of all files in the system.

| Field | Type | Description |
|---|---|---|
| Fileid | Int 4 | File ID |
| Objectid | Int 4 | Object ID owning the file. If |
| | | this value is 0 then the |
| | | attached file is a profiles |
| | | attached file and the field |
| | | profile id should be used. |
| Profileid | Int 4 | The profile id that the |
| | | attachment belongs to. If this |
| | | field is 0 then the attachment |
| | | belongs to the object found in |
| | | the objectid field. |
| Userid | Int 4 | ID of file storing terminal. |
| Filename | Varchar 250 | File name on owning client. |
| Filesize | Int 4 | File size. |
| Hash | Varchar 32 | Hash |

FilesAux

This table keeps a list of variants of file located on other user terminals.

| Field | Type | Description |
|---|---|---|
| Fileid | Int 4 | File ID |
| Userid | Int 4 | ID to other file storing |
| | | terminals having the same |
| | | file |
| Filename | Varchar 250 | Local file name on other |
| | | client |
| Filesize | Int 4 | File size |
| Hash | Varchar 32 | Hash |

Currency

This table keeps a list of all currencies available in the system.

| Field | Type | Description |
|---|---|---|
| Currency | Char 3 | Currency code e.g. SEK, |
| | | USD, EUR |

Agent

This table keeps track of so-called agent searches in the server. An agent search includes sending an email to the profileid's email address whenever any new object is entered in the server after the date and time the agent search was created.

| Field | Type | Description |
|---|---|---|
| IntAgentID | Int 4 | Internal key for agent |
| | | search ID. |
| Profileid | Int 4 | The profile that the emails |
| | | should be sent to. |
| Category | Int 4 | Category to search |
| Type | Tinyint 1 | Type of objects to search |
| SearchString | Varchar 1000 | Complete search string send |
| | | by the client. |
| Updated | DateTime | Date and time the agent |
| | | search was entering in the |
| | | system. |

While the invention has been described with reference to specific exemplary embodiments, the description is only intended to illustrate the inventive concept and should not be taken as limiting the scope of the invention. Various alternatives, modifications and equivalents may be used without departing from the spirit of the invention, which is defined by the appended claims.

1. A method of advertising objects, said objects being offered in advertisements stored in a central server, said advertisements being accessible from the central server over the Internet to user terminals capable of web browsing or network browsing, the method comprising the following steps, executed in said central server:
A) receiving a request from a first user terminal for at least one electronic file used for describing and/or displaying one or more objects, the at least one file being indicated in an advertisement accessed from the central server by the first user terminal, wherein said at least one file is distinct from the one or more objects offered in the advertisement,
B) determining at least one second user terminal being registered with the central server as having the at least one requested file availably stored, in response to the received file request, and based on file information stored in a server database, and
C) initiating a communication connection between the first and second user terminals if the first user terminal requests a file transfer to the first user terminal, such that the at least one requested file can be transferred directly from the second user terminal to the first user terminal.

2. A method according to claim 1, wherein the file is transferred from the second user terminal to the first user terminal by means of file transfer enabling computer programs installed in the first and second user terminals, respectively, without requiring any further action from the central server.

3. A method according to claim 2, wherein the initiating step C) includes sending a file transfer command from the central server to the first user terminal to activate said file transfer enabling computer program in the first user terminal for pulling the at least one requested file from the second user terminal.

4. A method according to claim 3, wherein the first user terminal is first prompted to fetch said file transfer enabling computer program from the central server, if said computer program is not already installed in the first user terminal.

5. A method according to claim 3, wherein said file transfer command includes a network address of the second user terminal and the storing location of the requested file in the second user terminal.

6. A method according to claim 5, wherein said file transfer command further includes said file transfer enabling computer program from the central server, if said computer program is not already installed in the first user terminal.

7. A method according to claim 2, wherein the initiating step C) includes sending a file transfer command from the central server to the second user terminal to activate said file transfer enabling computer program in the second user terminal for pushing the at least one requested file to the first user terminal.

8. A method according to claim 7, wherein said file transfer command includes a network address of the first user terminal and the storing location of the requested file in the second user terminal.

9. A method according to claim 1, wherein a communication connection is initiated in step C) between the second user terminal determined in step B) and a third user terminal, if the first user terminal requests a file transfer to the third user terminal, such that the at least one requested file can be transferred directly from the second user terminal to the third user terminal instead of to the first user terminal, wherein said first user terminal acts as a remote control user terminal from which the file request is received in step A).

10. A method according to claim 9, wherein a file transfer enabling computer program has previously been installed in the third user terminal, enabling the third user terminal to receive the at least one requested file from the second user terminal.

11. A method according to claim 9, wherein a customer controlling the first and third user terminals has been assigned a login ID/password combination which is valid for at least the third user terminal, such that a remote file request can be sent from any terminal, provided that the correct login ID/password combination is entered.

12. A method according to claim 1, comprising the further step of registering the first user terminal with the central server as having said at least one requested file availably stored therein after being transferred, wherein a file transfer enabling computer program installed in the first user terminal enables the first user terminal to send the at least one requested file to any other user terminal also requesting that file.

13. A method according to claim 1, wherein the determining step B) includes retrieving from a server database of the central server information on the at least one requested file, said server database comprising stored file information on a plurality of files and their associated user terminals in which those files are locally stored.

14. A method according to claim 13, wherein the retrieved file information includes a file format.

15. A method according to claim 13, wherein the retrieved file information includes a file size.

16. A method according to claim 13, wherein the retrieved file information further includes a network address of said second user terminal and the storing location of the requested file in said second user terminal.

17. A method according to claim 1, wherein a plurality of electronic files are indicated in the advertisement.

18. A method according to claim 1, wherein the central server serves as a trading site for offering objects to customers.

19. A method according to claim 1, wherein the advertisements stored in the central server concern objects offered for sale or exchange or hire/rent or giveaway or publication or as wanted.

20. A method according to claim 1, wherein the file request concerns at least one of the following file types: text, image, voice, audio and video in any size and in any format or format combination.

21. A method according to claim 1, wherein a plurality of user terminals are determined in step B), wherein the at least one requested file is availably stored in each of the determined user terminals.

22. A method according to claim 21, comprising the further step of, before the initiating step C), selecting the most rapidly transmitting user terminals, out of the determined user terminals, for file transfer, from which the at least one requested file can be transferred by using the highest possible transmission rate.

23. A method according to claim 22, wherein the most rapidly transmitting user terminals are selected for file transfer based on transmission rates stored in the central server for the user terminals determined in step B).

24. A method according to claim 23, wherein the stored transmission rate for each user terminal is updated dynamically by means of a previously installed transmission rate computer program adapted to measure the transmission rate for executed file transfers and report the measurement results by sending a transmission rate report to the central server.

25. A method according to claim 21, wherein different portions of the at least one requested file are transferred substantially simultaneously from the selected plurality of user terminals, to provide the complete at least one requested file to the first user terminal.

26. A method according to claim 1, comprising the further step of creating and storing in the central server at least one client profile for advertisements, wherein the client profile is defined by profile data and is associated with a set of advertisements.

27. A method according to claim 26, comprising the further step of assigning a login ID/password combination to the client profile, authorizing the client to modify the profile and to add or remove advertisements associated with the profile, if the correct login ID/password combination is entered.

28. A method according to claim 27, wherein the assigned login ID/password combination can also be used for controlling file transfers to user terminals.

29. A method according to claim 26, wherein the profile data include at least one of: contact information, geographical location, charging parameters, and one or more object categories.

30. A method according to claim 26, wherein the created at least one client profile can be used by customers for searching advertisements.

31. A method according to claim 26, wherein the created at least one client profile comprises a plurality of client subprofiles, each client subprofile being valid for a predetermined set of advertisements.

32. A method according to claim 1, wherein before steps A)-C) are executed, a client is registered with the central server including defining client data, said advertisement is created in the central server for the registered client based on the defined client data, and information on said at least one file indicated in the advertisement and the second user terminal is stored in the central server, wherein said second user terminal is controlled by the registered client and has the file originally stored.

33. A method according to claim 32, wherein the advertisement is automatically created for one or more objects if a predefined condition is fulfilled, according to the defined client data, wherein the advertisement is automatically created by means of an auto-client computer program adapted to check whether said predefined condition is fulfilled.

34. A method according to claim 33, said one or more objects having previously been offered for sale otherwise than by advertising in the central server, wherein the advertisement is automatically created if the one or more objects have remained unsold during a preset time period.

35. A method according to claim 1, comprising the further steps of receiving from a file storing user terminal a file availability report comprising information on which files are available for file transfer, and updating the central server according to the received file availability report.

36. A method according to claim 35, wherein the file availability report is received periodically or when the file availability in the file storing user terminal is changed.

37. A method according to claim 1, wherein user messages, such as chat messages, can be exchanged between the first and second user terminals after the communication connection has been initiated in step C).

38. A method according to claim 37, wherein user messages are exchanged comprising a negotiation for an advertised object.

39. A method according to claim 1, wherein at least one of said first and second user terminals is a mobile phone.

40. A method according to claim 1, wherein said at least one file indicated in the advertisement is tagged with an identity code identifying the file, wherein the identity code is used for retrieving the file from said second user terminal.

41. A method according to claim 1, wherein a partially transferred file is stored in a user terminal receiving a file transfer, if a first file transfer attempt has been interrupted, and that only the remainder of the partially stored file is transferred in a second attempt.

42. A central server for advertising objects, said objects being offered in advertisements stored in the central server, said advertisements being accessible from the central server over the Internet to user terminals capable of web browsing or network browsing, the central server comprising:
a receiving unit adapted to receive a request from a first user terminal for at least one electronic file used for describing and/or displaying one or more objects, the at least one file being indicated in an advertisement accessed from the central server by the first user terminal, wherein said at least one file is distinct from the one or more objects offered in the advertisement,
a server database for storing file information on a plurality of files and their associated user terminals in which those files are locally stored,
a logic unit adapted to determine at least one second user terminal being registered with the central server as having the at least one requested file availably stored therein, in response to the received file request, and
a transmitting unit adapted to initiate a communication connection between the first and second user terminals if the first user terminal requests a file transfer to the first user terminal, such that the at least one requested file can be transferred directly from the second user terminal to the first user terminal.

43. A central server according to claim 42, wherein the central server is adapted to send file transfer enabling computer programs to the first and second user terminals, enabling the file to be transferred from the second user terminal to the first user terminal, without requiring any further action from the central server.

44. A central server according to claim 43, wherein the central server is further adapted to send a file transfer command to the first user terminal to activate said file transfer enabling computer program in the first user terminal for pulling the at least one requested file from the second user terminal.

45. A central server according to claim 44, wherein the central server is further adapted to first prompt the first user terminal to fetch said file transfer enabling computer program from the central server, if said computer program is not already installed in the first user terminal.

46. A central server according to claim 43, wherein said file transfer command includes a network address of the second user terminal and the storing location of the requested file in the second user terminal.

47. A central server according to claim 46, wherein said file transfer command further includes said file transfer enabling computer program from the central server, if said computer program is not already installed in the first user terminal.

48. A central server according to claim 43, wherein the central server is further adapted to send a file transfer command to the second user terminal to activate said file transfer enabling computer program in the second user terminal for pushing the at least one requested file to the first user terminal.

49. A central server according to claim 48, wherein said file transfer command includes a network address of the first user terminal and the storing location of the requested file in the second user terminal.

50. A central server according to claim 42, wherein the transmitting unit is adapted to initiate a communication connection between the second user terminal and a third user terminal, if the first user terminal requests a file transfer to the third user terminal, such that the at least one requested file can be transferred directly from the second user terminal to the third user terminal, wherein said first user terminal acts as a remote control user terminal.

51. A central server according to claim 50, wherein the transmitting unit is further adapted to send a file transfer enabling computer program to the third user terminal, enabling the third user terminal to receive the at least one requested file from the second user terminal.

52. A central server according to claim 50, wherein the central server is further adapted to assign a login ID/password combination, which is valid for at least the third user terminal, to a customer controlling the first and third user terminals, such that a remote file request can be sent from any terminal, provided that the correct login ID/password combination is entered.

53. A central server according to claim 42, wherein the central server is further adapted to register the first user terminal with the central server as having said at least one requested file availably stored therein after being transferred, wherein a file transfer enabling computer program installed in the first user terminal enables the first user terminal to send the at least one requested file to any other user terminal also requesting that file.

54. A central server according to claim 42, wherein the logic unit is adapted to retrieve from the server database information on said second user terminal and the at least one requested file.

55. A central server according to claim 54, wherein the retrieved file information includes a network address of said second user terminal and the storing location of the at least one requested file in said second user terminal.

56. A central server according to claim 42, wherein the central server is adapted to serve as a trading site for offering objects to customers.

57. A central server according to claim 42, wherein the logic unit is adapted to determine a plurality of user terminals, wherein the at least one requested file is availably stored in each of the determined user terminals.

58. A central server according to claim 57, wherein the logic unit is further adapted to select the most rapidly transmitting user terminals, out of the determined user terminals, for file transfer, from which the at least one requested file can be transferred by using the highest possible transmission rate.

59. A central server according to claim 58, wherein the logic unit is further adapted to select the most rapidly transmitting user terminals for file transfer, based on transmission rates stored in the server database for the determined user terminals.

60. A central server according to claim 59, wherein the logic unit is further adapted to update the stored transmission rate dynamically for each user terminal, based on executed file transfers.

61. A central server according to claim 59, wherein the logic unit is further adapted to select a plurality of user terminals for file transfer, out of the determined user terminals, such that different portions of the at least one requested file can be transferred substantially simultaneously from the selected plurality of user terminals, to provide the complete at least one requested file to the first user terminal.

62. A central server according to claim 42, wherein the logic unit is adapted to create and store in the central server at least one client profile for advertisements, wherein the client profile is defined by profile data and is associated with a set of advertisements.

63. A central server according to claim 62, wherein the central server is further adapted to assign a login ID/password combination to the client profile, authorizing the client to modify the profile and to add or remove advertisements associated with the profile, if the correct login ID/password combination is entered.

64. A central server according to claim 63, wherein the assigned login ID/password combination can also be used for controlling file transfers to user terminals.

65. A central server according to claim 62, wherein the profile data include at least one of: contact information, geographical location, charging parameters, and one or more object categories.

66. A central server according to claim 62, wherein the created at least one client profile can be used by customers for searching advertisements.

67. A central server according to claim 62, wherein the created at least one client profile comprises a plurality of client subprofiles, each client subprofile being valid for a predetermined set of advertisements.

68. A central server according to claim 42, comprising a registration unit adapted to register a client with the central server including defining client data, to create the advertisement in the central server for the registered client based on the defined client data, and to store in the server database information on said at least one file indicated in the advertisement and the second user terminal, wherein said second user terminal is controlled by the registered client and has the file originally stored.

69. A central server according to claim 68, wherein the registration unit is further adapted to create the advertisement for one or more objects automatically if a predefined condition is fulfilled, according to the defined client data, wherein the advertisement is automatically created by means of an auto-client computer program adapted to check whether said predefined condition is fulfilled.

70. A central server according to claim 69, said one or more objects having previously been offered for sale otherwise than by advertising in the central server, wherein the registration unit is further adapted to automatically create the advertisement if the one or more objects have remained unsold during a preset time period.

71. A central server according to claim 42, wherein the receiving unit is further adapted to receive from a file storing user terminal a file availability report comprising information on which files are available for file transfer, wherein the logic unit is adapted to update the server database according to the received file availability report.

72. A central server according to claim 42, wherein the logic unit is adapted to tag said at least one file indicated in the advertisement with an identity code identifying the file, wherein the identity code is used for retrieving the file from said second user terminal.

73. A method of advertising objects, said objects being offered in advertisements stored in a central server, said advertisements being accessible from the central server over the Internet to user terminals capable of web browsing or network browsing, comprising the following steps, executed in said central server:
a) registering a client with the central server including defining client data,
b) creating an advertisement in the central server for the registered client based on the defined client data,
c) indicating in the advertisement at least one file being stored locally in at least one registered user terminal, wherein the at least one indicated file is used for describing and/or displaying one or more objects offered in the advertisement, and wherein the at least one indicated file is distinct from the one or more objects offered in the advertisement,
d) storing information in a server database of the central server on the at least one indicated file and the at least one file storing user terminal, and
e) initiating a communication connection for transferring the at least one indicated file from the file storing user terminal to a file requesting user terminal accessing the advertisement from the central server and requesting that file.

74. A method according to claim 73, comprising the further step of registering the file requesting user terminal with the central server as having said at least one requested file availably stored therein after being transferred, wherein a file transfer enabling computer program installed in the file requesting user terminal enables the file requesting user terminal to send the at least one requested file to any other user terminal also requesting that file.

75. A method according to claim 73, comprising the further step of creating and storing in the central server at least one client profile for the registered client, wherein the client profile is defined by profile data and is associated with a set of advertisements.

76. A method according to claim 75, comprising the further step of assigning a login ID/password combination to the client profile, authorizing the registered client to modify the profile and to add or remove advertisements associated with the profile, if the correct login ID/password combination is entered.

77. A method according to claim 76, wherein the assigned login ID/password combination can also be used for controlling file transfers to user terminals.

78. A method according to claim 75, wherein the profile data include at least one of: contact information, geographical location, charging parameters, and one or more object categories.

79. A method according to claim 75, wherein the created at least one client profile can be used by customers for searching advertisements.

80. A method according to claim 75, wherein the created at least one client profile comprises a plurality of client subprofiles, each client subprofile being valid for a predetermined set of advertisements.

81. A method according to claim 73, wherein the advertisement is automatically created in step b) for one or more objects if a predefined condition is fulfilled, according to the defined client data, wherein the advertisement is automatically created by means of an auto-client computer program adapted to check whether said predefined condition is fulfilled.

82. A method according to claim 81, said one or more objects having previously been offered for sale otherwise than by advertising in the central server, wherein the advertisement is automatically created if the one or more objects have remained unsold during a preset time period.

83. A method according to claim 73, comprising the further steps of receiving from a file storing user terminal a file availability report comprising information on which files are available for file transfer, and updating the server database according to the received file availability report.

84. A method according to claim 83, wherein the file availability report is received periodically or when the file availability in the file storing user terminal is changed.

85. A central server for advertising objects, said objects being offered in advertisements stored in a central server, said advertisements being accessible from the central server over the Internet to user terminals capable of web browsing or network browsing, the central server comprising:
a registration unit adapted to register a client with the central server including defining client data, to create an advertisement in the central server for the registered client based on the defined client data, and to indicate in the advertisement at least one file being stored locally in at least one registered user terminal, wherein the at least one indicated file is used for describing and/or displaying one or more objects offered in the advertisement, and wherein the at least one indicated file is distinct from the one or more objects offered in the advertisement,
a server database for storing file information on a plurality of files and their associated user terminals in which those files are locally stored,
a receiving unit adapted to receive a request for the at least one indicated file from a user terminal accessing said advertisement from the central server,
a logic unit for determining at least one file storing user terminal in response to the received file request, and
a transmitting unit adapted to initiate a communication connection for transferring the at least one indicated file from a user terminal storing that file to the file requesting user terminal.

86. A central server according to claim 85, wherein said registration unit is further adapted to register the file requesting user terminal as having said at least one requested file availably stored therein after being transferred, wherein a file transfer enabling computer program installed in the file requesting user terminal enables the file requesting user terminal to send the at least one requested file to any other user terminal also requesting that file.

87. A central server according to claim 85, wherein said registration unit is further adapted to create at least one client profile for the registered client, wherein the client profile is defined by profile data and is associated with a set of advertisements.

88. A central server according to claim 87, wherein said registration unit is further adapted to assign a login ID/password combination to the client profile, authorizing the registered client to modify the profile and to add or remove advertisements associated with the profile, if the correct login ID/password combination is entered.

89. A central server according to claim 88, wherein the assigned login ID/password combination can also be used for controlling file transfers to user terminals.

90. A central server according to claim 89, wherein the profile data include at least one of: contact information, geographical location, charging parameters, and one or more object categories.

91. A central server according to claim 87, wherein the created at least one client profile can be used by customers for searching advertisements.

92. A central server according to claim 87, wherein the created at least one client profile comprises a plurality of client subprofiles, each client subprofile being valid for a predetermined set of advertisements.

93. A central server according to claim 83, wherein said registration unit is further adapted to automatically create the advertisement for one or more objects if a predefined condition is fulfilled, according to defined client data, such that the advertisement is automatically created by means of an auto-client computer program adapted to check whether said predefined condition is fulfilled.

94. A central server according to claim 93, said one or more objects having previously been offered for sale otherwise than by advertising in the central server, wherein said registration unit is further adapted to automatically create the advertisement if the one or more objects have remained unsold during a preset time period.

95. A central server according to claim 85, wherein said receiving unit is further adapted to receive from a file storing user terminal a file availability report comprising information on which files are available for file transfer, and that said logic unit is further adapted to update the server database according to the received file availability report.

96. A central server according to claim 95, wherein said receiving unit is further adapted to receive the file availability report periodically or when the file availability in the file storing user terminal is changed.

97. A method of advertising objects, said objects being offered in advertisements stored in a central server, said advertisements being accessible from the central server over the Internet to user terminals capable of web browsing or network browsing, the method comprising the following steps, executed in said central server:
A) receiving a request from a first user terminal for at least one electronic file used for describing and/or displaying one or more objects, the at least one file being indicated in an advertisement accessed from the central server by the first user terminal, wherein said at least one file is distinct from the one or more objects offered in the advertisement,
B) determining at least one second user terminal being registered with the central server as having the at least one requested file availably stored, in response to the received file request, and
C) initiating a communication connection between the second user terminal and a third user terminal being registered with the central server, such that the at least one requested file can be transferred directly from the second user terminal to the third user terminal.

98. A method according to claim 97, wherein the file is transferred from the second user terminal to the third user terminal by means of file transfer enabling computer programs installed in the second and third user terminals, respectively, without requiring any further action from the central server.

99. A method according to claim 98, wherein a file transfer enabling computer program has previously been installed in the third user terminal, enabling the third user terminal to receive the at least one requested file from the second user terminal.

100. A method according to claim 99, wherein the initiating step C) includes sending a file transfer command from the central server to the third user terminal to activate said file transfer enabling computer program in the third user terminal for pulling the at least one requested file from the second user terminal.

101. A method according to claim 100, wherein said file transfer command includes a network address of the second user terminal and the storing location of the requested file in the second user terminal.

102. A method according to claim 99, wherein the initiating step C) includes sending a file transfer command from the central server to the second user terminal to activate said file transfer enabling computer program in the second user terminal for pushing the at least one requested file to the third user terminal.

103. A method according to claim 102, wherein said file transfer command includes a network address of the third user terminal and the storing location of the requested file in the second user terminal.

104. A method according to claim 97, wherein a customer controlling the first and third user terminals has been assigned a login ID/password combination which is valid for at least the third user terminal, such that a remote file request can be sent from any terminal, provided that the correct login ID/password combination is entered.

105. A method according to claim 97, comprising the further step of registering the third user terminal with the central server as having said at least one requested file availably stored therein after being transferred, wherein a file transfer enabling computer program installed in the third user terminal enables the third user terminal to send the at least one requested file to any other user terminal also requesting that file.

106. A central server for advertising objects, said objects being offered in advertisements stored in a central server, said advertisements being accessible from the central server over the Internet to user terminals capable of web browsing or network browsing, the central server comprising:
a receiving unit adapted to receive a request from a first user terminal for at least one electronic file used for describing and/or displaying one or more objects, the at least one file being indicated in an advertisement accessed from the central server by the first user terminal, wherein said at least one file is distinct from the one or more objects offered in the advertisement,
a server database for storing file information on a plurality of files and their associated user terminals in which those files are locally stored,
a logic unit adapted to determine at least one second user terminal being registered with the central server as having the at least one requested file availably stored, in response to the received file request, and
a transmitting unit adapted to initiate a communication connection between the second user terminal and a third user terminal being registered with the central server, such that the at least one requested file can be transferred directly from the second user terminal to the third user terminal.

107. A central server according to claim 106, wherein the central server is adapted to send file transfer enabling computer programs to the second and third user terminals, enabling the file to be transferred from the second user terminal to the third user terminal, without requiring any further action from the central server.

108. A central server according to claim 107, wherein the central server is adapted to send a file transfer enabling computer program to the third user terminal, enabling the third user terminal to receive the at least one requested file from the second user terminal.

109. A central server according to claim 108, wherein the central server is adapted to send a file transfer command to the third user terminal to activate said file transfer enabling computer program in the third user terminal for pulling the at least one requested file from the second user terminal.

110. A central server according to claim 109, wherein said file transfer command includes a network address of the second user terminal and the storing location of the requested file in the second user terminal.

111. A central server according to claim 108, wherein the central server is adapted to send a file transfer command to the second user terminal to activate said file transfer enabling computer program in the second user terminal for pushing the at least one requested file to the third user terminal.

112. A central server according to claim 111, wherein said file transfer command includes a network address of the third user terminal and the storing location of the requested file in the second user terminal.

113. A central server according to claim 106, wherein the central server is adapted to assign a login ID/password combination to a customer controlling the first and third user terminals, which is valid for at least the third user terminal, such that a remote file request can be sent from any terminal, provided that the correct login ID/password combination is entered.

114. A central server according to claim 106, wherein the central server is adapted to register the third user terminal as having said at least one requested file availably stored therein after being transferred, wherein a file transfer enabling computer program installed in the third user terminal enables the third user terminal to send the at least one requested file to any other user terminal also requesting that file.

115. A method of supplying electronic files to user terminals capable of web browsing or network browsing, said electronic files being accessible by means of a central server over the Internet, the method comprising the following steps, executed in said central server:
A) receiving a request from a first user terminal for at least one electronic file indicated by the central server when accessed by the first user terminal,
B) determining at least one second user terminal being registered with the central server as having the at least one requested file availably stored, in response to the received file request, and
C) initiating a communication connection between the second user terminal and a third user terminal being registered with the central server, such that the at least one requested file can be transferred directly from the second user terminal to the third user terminal.

116. A method according to claim 115, wherein the file is transferred from the second user terminal to the third user terminal by means of file transfer enabling computer programs installed in the second and third user terminals, respectively, without requiring any further action from the central server.

117. A method according to claim 116, wherein a file transfer enabling computer program has previously been installed in the third user terminal, enabling the third user terminal to receive the at least one requested file from the second user terminal.

118. A method according to claim 117, wherein the initiating step C) includes sending a file transfer command from the central server to the third user terminal to activate said file transfer enabling computer program in the third user terminal for pulling the at least one requested file from the second user terminal.

119. A method according to claim 118, wherein said file transfer command includes a network address of the second user terminal and the storing location of the requested file in the second user terminal.

120. A method according to claim 117, wherein the initiating step C) includes sending a file transfer command from the central server to the second user terminal to activate said file transfer enabling computer program in the second user terminal for pushing the at least one requested file to the third user terminal.

121. A method according to claim 120, wherein said file transfer command includes a network address of the third user terminal and the storing location of the requested file in the second user terminal.

122. A method according to claim 115, wherein a customer controlling the first and third user terminals has been assigned a login ID/password combination which is valid for at least the third user terminal, such that a remote file request can be sent from any terminal, provided that the correct login ID/password combination is entered.

123. A method according to claim 115, comprising the further step of registering the third user terminal with the central server as having said at least one requested file availably stored therein after being transferred, wherein a file transfer enabling computer program installed in the third user terminal enables the third user terminal to send the at least one requested file to any other user terminal also requesting that file.

124. A central server for supplying electronic files to user terminals capable of web browsing or network browsing, said electronic files being accessible by means of the central server over the Internet, the central server comprising:
a receiving unit adapted to receive a request from a first user terminal for at least one electronic file indicated by the central server when accessed by the first user terminal,
a server database for storing file information on a plurality of files and their associated user terminals in which those files are locally stored,
a logic unit adapted to determine at least one second user terminal being registered with the central server as having the at least one requested file availably stored, in response to the received file request, and
a transmitting unit adapted to initiate a communication connection between the second user terminal and a third user terminal being registered with the central server, such that the at least one requested file can be transferred directly from the second user terminal to the third user terminal.

125. A central server according to claim 124, wherein the central server is adapted to send file transfer enabling computer programs to the second and third user terminals, enabling the file to be transferred from the second user terminal to the third user terminal, without requiring any further action from the central server.

126. A central server according to claim 125, wherein the central server is adapted to send a file transfer enabling computer program to the third user terminal, enabling the third user terminal to receive the at least one requested file from the second user terminal.

127. A central server according to claim 126, wherein the central server is adapted to send a file transfer command to the third user terminal to activate said file transfer enabling computer program in the third user terminal for pulling the at least one requested file from the second user terminal.

128. A central server according to claim 127, wherein said file transfer command includes a network address of the second user terminal and the storing location of the requested file in the second user terminal.

129. A central server according to claim 126, wherein the central server is adapted to send a file transfer command to the second user terminal to activate said file transfer enabling computer program in the second user terminal for pushing the at least one requested file to the third user terminal.

130. A central server according to claim 129, wherein said file transfer command includes a network address of the third user terminal and the storing location of the requested file in the second user terminal.

131. A central server according to claim 124, wherein the central server is adapted to assign a login ID/password combination to a customer controlling the first and third user terminals, which is valid for at least the third user terminal, such that a remote file request can be sent from any terminal, provided that the correct login ID/password combination is entered.

132. A central server according to claim 124, wherein the central server is adapted to register the third user terminal as having said at least one requested file availably stored therein after being transferred, wherein a file transfer enabling computer program installed in the third user terminal enables the third user terminal to send the at least one requested file to any other user terminal also requesting that file.
